(19) United States
(12) Patent Application Publication
(10) Pub. No.: US 2008/0156424 A1
(43) Pub. Date: Jul. 3, 2008

(54) Coloured Polymer System with Improved Elasticity

(76) Inventors: Reinhold J. Leyrer, Dannstadt-Schauernheim (DE); Stephan Altmann, Deidesheim (DE); Oihana Elizalde, Mannheim (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/913,810

(22) PCT Filed: May 16, 2006
(86) PCT No.: PCT/EP06/62348

§ 371 Date: Nov. 7, 2007

(30) Foreign Application Priority Data
May 19, 2005 (DE) 10 2005 023 804.1

(51) Int. Cl. B32B 37/10; C08L 33/08

(52) U.S. Cl. 156/230; 525/50; 525/85

(57) ABSTRACT

Process for improvement of the elasticity of a colored polymer system, which is composed of a matrix and of discrete polymer particles distributed in accordance with a defined spatial lattice structure in the matrix, and which is obtained by filming of an emulsion polymer with core/shell structure, where the emulsion polymer is obtainable via polymerization of monomers in at least one first stage (monomers of the core) and subsequent polymerization of monomers in at least one further, second stage (monomers of the shell), which comprises using monomers whose glass transition temperature is below 0° C. as at least 5% by weight of the monomers of the core.

The invention relates to a process for improvement of the elasticity of a colored polymer system, which is composed of a matrix and of discrete polymer particles distributed in accordance with a defined spatial lattice structure in the matrix, and which is obtained by filming of an emulsion polymer with core/shell structure, where the emulsion polymer is obtainable via polymerization of monomers in at least one first stage (monomers of the core) and subsequent polymerization of monomers in at least one further, second stage (monomers of the shell), which comprises using monomers whose glass transition temperature is below 0° C. as at least 5% by weight of the monomers of the core.

The invention further relates to colored polymer systems which are obtainable by this process, and to the use of the colored polymer systems for coating by way of example of plastics or paper, or in visual displays.

DE-19717879, DE-19820302, and DE-19834194, and DE-A-10321083 disclose colored polymer systems in which discrete polymer particles have been distributed within a matrix.

DE 10229732 (PF 53679) describes the use of polymer layers of this type in visual display elements.

It was an object of the present invention to improve the elasticity of the colored polymer systems and, respectively, of the colored polymer films produced therefrom. The polymer films are intended to have maximum resistance to mechanical stresses, for example those that can arise during use of polymer films in displays. Accordingly, the process described at the outset has been found.

The colored polymer systems are composed in essence of a matrix and of discrete polymer particles distributed in accordance with a defined spatial lattice structure in the matrix.

The use of emulsion polymers with core/shell structure for preparation of colored polymer systems of this type has been described previously in the prior art (see DE-A-19820302, DE-A-19834194).

The colored polymer system is obtained via filming of an emulsion polymer with core/shell structure.

The shell of the emulsion polymer can be filmed and forms the matrix, while the cores of the emulsion polymer are discrete polymer particles distributed in the matrix.

The emulsion polymer is correspondingly obtained via a multistage emulsion polymerization reaction,

where
the monomers which form the core are first polymerized in at least one 1st stage, and, the monomers which form the filmable shell are then polymerized in at least one 2nd stage.

The monomer constitution of the core differs from that of the shell. Monomers with high glass transition temperature (Tg) are used in the core, whereas the monomers of the shell have lower Tg.

The glass transition temperature (Tg) calculated by the Fox equation for the monomer mixture of the 1st stage (core) is preferably from 0 to 150° C., particularly preferably from 0 to 120° C., very particularly preferably from 0 to 110° C.

The Tg also calculated in accordance with Fox for the monomer mixture of the 2nd stage (shell) is preferably from −50 to 110° C., particularly preferably from −40 to 25° C. The Tg of the monomer mixture of the 2nd stage is preferably lower by at least 10° C., particularly preferably by at least 20° C., than the Tg of the monomer mixture of the 1st stage.

A significant feature of the present invention is that the monomer mixture of the 1st stage also comprises monomers whose Tg is below 0° C., preferably below −20° C., particularly preferably below −30° C.

The proportion of these monomers, based on all of the monomers of the 1st stage, is at least 5% by weight, preferably at least 10% by weight, particularly preferably at least 20% by weight, in particular at least 30 or 40% by weight. The selection of the other monomers of the 1st stage is such as to give compliance with the above Tg range for the 1st stage.

Preferred monomers with low Tg are alkyl(meth)acrylates, in particular n-butyl acrylate and 2-ethylhexyl acrylate. The other monomers in particular comprise styrene, crosslinking monomers, and, if appropriate, auxiliary monomers, such as acrylic acid, methacrylic acid.

It is known from the prior art that the core is a crosslinked core, whereas the shell is a non-crosslinked shell.

For the purposes of the present invention, it is preferable that the monomers of the 2nd stage (shell) also comprise crosslinking monomers.

Crosslinking monomers are in particular monomers having two polymerizable groups, e.g. having two vinyl groups or allyl groups. Mention may be made of divinylbenzene, alkanediol diacrylates, or diallyl phthalate.

The proportion of the crosslinking monomers in the monomer mixture for the 1st stage is preferably from 0.5 to 25% by weight, particularly preferably from 1 to 7% by weight, very particularly preferably from 2 to 6% by weight, based on the monomers of the 1st stage.

The proportion of the crosslinking monomers in the monomer mixture for the 2nd stage is preferably from 0.01 to 10% by weight, particularly preferably from 0.1 to 5% by weight, very particularly preferably from 0.1 to 3% by weight, based on the monomers of the 2nd stage.

The weight of the crosslinking monomers of the 1st stage is preferably at least twice as great as the weight of the crosslinking monomers of the 2nd stage.

For the purposes of the present invention, it is also preferable that the polymerization of the monomers of the 1st and/or of the 2nd stage is carried out in the presence of a UV absorber. The polymer correspondingly comprises a UV absorber.

It is particularly preferable that the polymerization of the 1st stage (core) is carried out in the presence of an absorber for electromagnetic radiation, in particular of a UV absorber.

Examples of UV absorbers that may be used are hydroxybenzophenones or hydroxyphenylbenzotriazoles.

An example of a known UV absorber of this type has the trademark Uvinul® 3033P.

The amount of the absorbers is in particular from 0.1 to 5% by weight, particularly preferably from 0.2 to 3% by weight, based on the entire polymer. The entire amount is preferably used during the polymerization of the 1st stage.

For the purposes of the present invention, it is also preferable that the polymerization of the monomers of the 1st and/or of the 2nd stage is carried out in the presence of different emulsifiers. If emulsifiers having an ionic group (ionic emulsifiers) are used during the polymerization of the monomers of the core, emulsifiers without ionic groups (nonionic emulsifiers) are then preferably used during the polymerization of the monomers of the shell. Conversely, ionic emulsifiers are used during the polymerization of the monomers of the shell if the polymerization of the monomers of the core has been carried out in the presence of nonionic emulsifiers.

The descriptions below apply to the nature of the emulsifiers and the amount.

In one preferred embodiment for preparation of the emulsion polymer, the monomers of the shell are metered in during the polymerization reaction in less than 90 minutes, particularly preferably in less than 60 minutes, and in particular in less than 30 minutes. The polymerization of the monomers of the shell very particularly preferably takes place in batch mode, meaning that all of the monomers of the shell are introduced into the polymerization vessel in maximum simultaneity, generally within a few minutes, e.g. at most 10 or at most 5 minutes, and are then polymerized.

It is preferable that more than 90% by weight of the entire amount of initiator used for the emulsion polymerization has been added prior to the start of addition of the monomers of the shell, and it is particularly preferable that the entire amount of initiator used for the emulsion polymerization has been added prior to the start of addition of the monomers of the shell.

General descriptions concerning core/shell polymer:

The ratio by weight of the monomers which form the non-filming core to the monomers which form the filming shell is preferably from 1:0.05 to 1:20, particularly preferably from 1:0.2 to 1:5.

The following particularly preferably applies to the proportion of the stages, based on the entire polymer:

1st stage (core) from 10 to 90% by weight, particularly preferably from 40 to 60% by weight.
2nd stage (shell) from 10 to 90% by weight, particularly preferably from 40 to 60% by weight.

The entire emulsion polymer is preferably composed of at least 40% by weight, with preference at least 60% by weight, with particular preference at least 80% by weight, of what are known as main monomers.

The main monomers have been selected from C₁-C₂₀-alkyl(meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising from 1 to 10 carbon atoms, aliphatic hydrocarbons having from 2 to 8 carbon atoms and 1 or 2 double bonds, or mixtures of these monomers.

By way of example, mention may be made of alkyl(meth)acrylates having a C₁-C₁₀-alkyl radical, e.g. methyl methacrylate, methyl acrylate, n-butyl acrylate, ethyl acrylate, and 2-ethylhexyl acrylate.

Mixtures of the alkyl(meth)acrylates are also particularly suitable.

Examples of vinyl esters of carboxylic acids which have from 1 to 20 carbon atoms are vinyl laurate, vinyl stearate, vinyl propionate, vinyl versatate, and vinyl acetate.

Vinylaromatic compounds which may be used are vinyltoluene, α- and p-methylstyrene, alpha-butylstyrene, 4-n-butylstyrene, 4-n-decylstyrene, and preferably styrene. Examples of nitriles are acrylonitrile and methacrylonitrile.

The vinyl halides are chlorine-, fluorine-, or bromine-substituted ethylenically unsaturated compounds, preferably vinyl chloride and vinylidene chloride.

By way of example of vinyl ethers, mention may be made of vinyl methyl ether or vinyl isobutyl ether. Preference is given to a vinyl ether of alcohols which comprise from 1 to 4 carbon atoms.

As hydrocarbons having from 2 to 8 carbon atoms and one or two olefinic double bonds, mention may be made of butadiene, isoprene, and chloroprene, examples having one double bond being ethylene or propylene.

Preferred main monomers are the C₁-C₂₀-alkyl acrylates and C₁-C₂₀-alkyl methacrylates, in particular C₁-C₈-alkyl acrylates and C₁-C₈-alkyl methacrylates, vinylaromatics, in particular styrene, and mixtures of these, and also in particular mixtures of the alkyl(meth)acrylates and vinylaromatics.

Very particular preference is given to methyl acrylate, methyl methacrylate, ethyl acrylate, n-butyl acrylate, n-hexyl acrylate, octyl acrylate, and 2-ethylhexyl acrylate, and styrene, and also mixtures of these monomers.

The emulsion polymer is prepared by emulsion polymerization. The emulsion polymerization method uses ionic and/or non-ionic emulsifiers and/or protective colloids, or stabilizers as surface-active compounds.

A detailed description of suitable protective colloids is found in Houben-Weyl, Methoden der organischen Chemie, volume XIV/1, Makromolekulare Stoffe, Georg-Thieme-Verlag, Stuttgart, 1961, pp. 411-420. Emulsifiers which may be used are either anionic, cationic or non-ionic emulsifiers. The surface-active substances preferably comprise emulsifiers whose molecular weight is usually below 2000 g/mol, in contrast to that of protective colloids.

The amounts usually used of the surface-active substance are from 0.1 to 10% by weight, based on the monomers to be polymerized.

Examples of water-soluble initiators for the emulsion polymerization are the ammonium and alkali metal salts of peroxydisulfuric acid, e.g. sodium peroxodisulfate, hydrogen peroxide, or organic peroxides, e.g. tert-butyl hydroperoxide.

The systems known as reduction-oxidation (redox) initiator systems are also suitable.

Redox initiator systems are composed of at least one, mostly inorganic, reducing agent, and of an inorganic or organic oxidant.

The abovementioned initiators for the emulsion polymerization are examples of the oxidation component.

Examples of the reduction components are alkali metal salts of sulfurous acid, e.g. sodium sulfite, sodium hydrogensulfite, alkali metal salts of disulfurous acid, such as sodium disulfite, bisulfite addition compounds of aliphatic aldehydes and ketones, such as acetone bisulfite, or reducing agents such as hydroxymethanesulfinic acid and its salts, or ascorbic acid. When the redox initiator systems are used, concomitant use may be made of soluble metal compounds whose metallic component can occur in more than one valence state.

Examples of conventional redox initiator systems are ascorbic acid/ferrous sulfate/sodium peroxodisulfate, tert-butyl hydroperoxide/sodium disulfite, tert-butyl hydroperoxide/Na hydroxymethanesulfinic acid. The individual components, e.g. the reduction component, may also be mixtures, e.g. a mixture of the sodium salt of hydroxymethanesulfinic acid and sodium disulfite.

The amount of the initiators is generally from 0.1 to 10% by weight, preferably from 0.5 to 5% by weight, based on the monomers to be polymerized. It is also possible to use two or more different initiators in the emulsion polymerization.

The emulsion polymerization generally takes place at from 30 to 130° C., preferably from 50 to 90° C. The polymerization medium may be composed either entirely of water or else of mixtures of water and liquids miscible therewith, for example methanol. It is preferable to use only water. The emulsion polymerization may be carried out either as a batch process or else as a feed process, which includes a staged or gradient method. Preference is given to the feed process, in which some of the polymerization mixture forms an initial charge and is heated to the polymerization temperature and begins to polymerize, and then the remainder of the polymerization mixture is introduced to the polymerization zone continuously, in stages, or in accordance with a concentration gradient, usually via two or more spatially separated feeds, of which one or more comprise(s) the monomers in pure or emulsified form, so as to maintain progress of the polymerization. A polymer seed may also form an initial charge in the polymerization for better particle-size control, for example.

Before the addition of the monomers of the next stage is begun, the polymerization of the monomers of the monomer mixture of the 1^{st} or 2^{nd} stage is preferably at least 90% by weight complete, particularly preferably at least 95% by weight complete, and very particularly preferably at least 99% by weight complete.

The average skilled worker is aware of the manner in which the initiator is added to the polymerization vessel during the course of the free-radical aqueous emulsion polymerization. All of the initiator may form an initial charge in the polymerization vessel, or else it may be used in a continuous or staged manner as required by its consumption in the course of the free-radical aqueous emulsion polymerization. The detail here depends on the chemical nature of the initiator system and also on the polymerization temperature. It is preferable for a portion to form an initial charge and for the remainder to be introduced to the polymerization zone as required by consumption.

Uniform particle size distribution, i.e. low polydispersity index, is obtainable via methods known to the skilled worker, e.g. by varying the amount of the surface-active compound (emulsifier or protective colloids) and/or appropriate stirrer speeds.

Initiator is also usually added after the end of the actual emulsion polymerization, i.e. after at least 95% conversion of the monomers, in order to remove the residual monomers.

The individual components may be added to the reactor during the feed process from above, at the side, or from below through the floor of the reactor.

The emulsion polymer may be filmed in the usual way with removal of the water, thereby forming the colored polymer system.

The polymer system produces a visual effect, i.e. an observable reflection, through interference generated by the light scattered at the polymer particles.

The wavelength of the reflection can be anywhere in the electromagnetic spectrum, depending on the distance between the polymer particles. The wavelength is preferably in the UV region, IR region, and in particular in the visible light region.

The wavelength of the observable reflection depends, in accordance with the known Bragg equation, on the distance between the lattice planes, in this case the distance between the polymer particles arranged in a spatial lattice structure in the matrix.

The proportion by weight of the matrix has in particular to be selected appropriately in order to establish the desired spatial lattice structure with the desired distance between the polymer particles. In the preparation methods described above, the appropriate amount of the organic compounds, e.g. polymeric compounds, should be used.

The proportion by weight of the matrix, i.e. the proportion of the filming shell, is in particular judged so that the spatial lattice structure produced and comprising the polymer particles reflects electromagnetic radiation in the desired region.

The distance between the polymer particles (in each case measured to the center of the particles) is suitably from 100 to 400 nm if a color effect, i.e. a reflection in the visible light region, is desired.

In order to develop a defined spatial lattice structure, the intention is that there should preferably be maximum uniformity of size of the discrete polymer particles. A measure of the uniformity of polymer particles is what is known as the polydispersity index, calculated by the formula

P.I.=(D₉₀−D₁₀)/D₅₀

where D₉₀, D₁₀, and D₅₀ indicate particle diameters, for which the following applies:
D₉₀: the particle diameter of 90% by weight of the total weight of all of the particles is smaller than or equal to D₉₀
D₅₀: the particle diameter of 50% by weight of the total weight of all of the particles is smaller than or equal to D₅₀
D₁₀: the particle diameter of 10% by weight of the total weight of all of the particles is smaller than or equal to D₁₀.

Further explanations concerning the polydispersity index are found by way of example in DE-A 19717879 (in particular drawings page 1).

The particle size distribution can be determined in a manner known per se, by way of example using an analytical ultracentrifuge (W. Mächtle, Makromolekulare Chemie 185 (1984) pages 1025-1039), or by hydrodynamic chromatography, and the resultant D₁₀, D₅₀, and D₉₀ values can be derived, and the polydispersity index determined.

As an alternative, the particle size and particle size distribution may also be determined by measuring light-scattering, using commercially available equipment (e.g. Autosizer 2C from Malvern, England).

The polymer particles preferably have a D₅₀ value in the range from 0.05 to 5 μm. The polymer particles may comprise one type of particle or two or more types of particle with different D₅₀ value, and each type of particle here preferably has a polydispersity index smaller than 0.6, particularly preferably smaller than 0.4, and very particularly preferably smaller than 0.3, and in particular smaller than 0.15.

The polymer particles are in particular composed of a single type of particle. The D₅₀ value is then preferably from 0.05 to 20 μm, particularly preferably from 100 to 400 nanometers.

The descriptions above concerning the particle size and particle size distribution for the discrete polymer particles are also applicable to the emulsion polymer itself.

A transparent polymer layer can be applied to the colored polymer system in order to improve the color brilliance and the stability of the colored polymer system, as described in DE-A-10321084, or material may be heated as described in DE-A-10321079.

The colored polymer systems obtainable or obtained by the inventive process have improved elasticity, color brilliance, and stability.

The colored polymer systems are suitable as, or in, coating compositions, e.g. for coating of plastics, plastics foils, fibrous systems, such as textiles or paper, packaging, etc., or in visual displays with changing color of the polymer layer, or for increasing luminous efficiency in visual displays, or for preparing color pigments, or for producing moldings, which, by way of example, can be produced via extrusion and which can be used for a very wide variety of purposes for which colored moldings are desired, e.g. in automobile construction or households. They are also suitable for solid preparations, in particular those described in EP-A-955323, or moldings such as those described in DE-A-10228228.

The invention also provides a process for producing substrates coated with a colored polymer system, which comprises applying the polymer system to a temporary carrier, e.g. via filming of an aqueous polymer system or via extrusion, and then transferring the coated side of the resultant coated carrier onto the substrate, e.g. by lamination or pressing, and, if appropriate, then peeling the temporary carrier. The coated carrier can be produced via conventional processes, e.g. filming of an aqueous polymer dispersion, or via extrusion or application under pressure of a solid polymer system. The subsequent lamination of the coated carrier to the substrate can be promoted via pressure or elevated temperature. Here again, it is possible to use the conventional processes. In particular, the coated carrier can be pretensioned, e.g. via traction, and can be in this stressed form when placed on the substrate. Blistering and defects can be avoided via subsequent heat treatment.

### EXAMPLES OF APPLICATION OF THE PATENT

All of the syntheses were carried out in a 2000 ml four-necked flask which had been provided with a reflux condenser, a nitrogen inlet tube, inlet tubes for supply of the monomer emulsion and of the initiator solution, and an anchor stirrer with a rotation rate of 150 revolutions per minute.

### COMPARATIVE EXAMPLE

613.38 g of water were used as initial charge in a reactor with anchor stirrer, thermometer, gas inlet tube, supply tubes, and reflux condenser, and then 3.47 g of polystyrene seed particle dispersion whose particle size was 30 nm and whose solids content was 33% by weight were added. The contents of the flask were then heated and stirred at a rotation rate of 150 rpm. During this time, nitrogen was introduced into the reactor. Once a temperature of 75° C. had been reached, the nitrogen feed was stopped and air was prevented from entering the reactor. Prior to the polymerization reaction, 85.71 g of feed 2 were introduced into the reactor and preoxidation took place for 5 minutes, and then the remainder of sodium persulfate solution was added within a period of 6.5 hours. At the same time, monomer emulsion a) of the core was metered in for 3 hours and 10 minutes, and then polymerization was continued for 20 minutes, and finally monomer emulsion b) of the shell was metered in over 3 hours. Once monomer addition had ended, the dispersion was permitted to continue polymerization for one hour. Cooling to room temperature then followed.

The constitution of the feeds was as follows:

Feed 1: monomer emulsion a)

| | | |
|---|---|---|
| 120.00 | g | of water |
| 19.29 | g | of Texapon NSO, conc. by weight: 28% in water |
| 4.32 | g | of sodium hydroxide solution, conc. by weight: |
| | | 25% in water |
| 27.00 | g | of diallyl phthalate |
| 7.35 | g | of methacrylic acid |
| 18.00 | g | of methyl methacrylate |
| 334.0 | g | of styrene |
| 9.00 | g | of rinsing water |

Feed 2: Initiator solution

| | |
|---|---|
| 171.43 g | of sodium peroxodisulfate, conc. by weight 7% in water |

Feed 3: Monomer emulsion b)

| | | |
|---|---|---|
| 243.00 | g | of water |
| 41.27 | g | of Texapon NSO, conc. by weight: 28% in water |
| 7.73 | g | of sodium hydroxide solution, conc. by weight: |
| | | 25% in water |
| 3.5 | g | of diallyl phthalate |
| 12.86 | g | of methacrylic acid |
| 827.4 | g | of n-butyl acrylate |
| 14.00 | g | of rinsing water |

### INVENTIVE EXAMPLE

397.28 g of water were used as initial charge in a reactor with anchor stirrer, thermometer, gas inlet tube, supply tubes, and reflux condenser, and then 1.42 g of polystyrene seed particle dispersion whose particle size was 30 nm and whose solids content was 33% by weight were added. The contents of the flask were then heated and stirred at a rotation rate of 150 rpm. During this time, nitrogen was introduced into the reactor. Once a temperature of 75° C. had been reached, the nitrogen feed was stopped and air was prevented from entering the reactor. Prior to the polymerization reaction, 20% of a sodium peroxodisulfate solution composed of 3.5 g of sodium persulfate in 46.5 g of water were introduced into the reactor and preoxidation was carried out for 5 minutes, and then the remainder of sodium persulfate solution was added within a period of 4.5 hours. At the same time, monomer emulsion a) of the core was metered in over a period of 2 hours, and then polymerization was continued for 30 minutes, and finally monomer emulsion b) of the shell was metered in over a period of 2 hours. After 1.5 hours during the feed of monomer emulsion b), feed 4 was added to the monomer emulsion b). Once monomer addition had ended, the dispersion was permitted to continue polymerization for one hour. The mixture was then cooled to room temperature.

The method corresponded to the previous example.

The constitution of the feeds was as follows:

Feed 1: monomer emulsion a)

| | | |
|---|---|---|
| 116.67 | g | of water |
| 8.75 | g | of Texapon NSO, conc. by weight: 28% in water |
| 0.7 | g | of sodium hydroxide solution, conc. by weight: |
| | | 25% in water |
| 14.0 | g | of acrylic acid |
| 14.00 | g | of diallyl phthalate |
| 168.0 | g | of styrene |
| 168.00 | g | of n-butyl acrylate |
| 7.00 | g | of rinsing water |

Feed 2: Initiator solution

| | |
|---|---|
| 50 g | of sodium peroxodisulfate, conc. by weight 7% in water |

Feed 3: Monomer emulsion b)

| | | |
|---|---|---|
| 116.67 | g | of water |
| 8.75 | g | of Texapon NSO, conc. by weight: 28% in water |
| 0.7 | g | of sodium hydroxide solution, conc. by weight: |
| | | 25% in water |
| 7.0 | g | of acrylic acid |
| 3.5 | g | of diallyl phthalate |
| 63.00 | g | of methyl methacrylate |
| 273.00 | g | of n-butyl acrylate |
| 7.00 | g | of rinsing water |

Feed 4: Acrylic acid

| | |
|---|---|
| 7.00 g | of acrylic acid |
| 6.00 g | of water |

### Results

### Properties of Polymer Dispersions Obtained

| | Comparative | Inventive |
|---|---|---|
| | example | example |
| Solids content in % by weight | 50.7 | 50.4 |
| Particle size (determined by | 328 | 381 |
| hydrodynamic chromatography, | | |
| HDF) | | |
| Polydispersity | 0.149 | 0.130 |
| PH | 5.8 | 3.3 |
| Light transmittance in % | 34 | 23 |
| Amount of coagulate in g | 3 | 2 |

### Film Production

The dispersions from the inventive example and comparative example were doctored (layer thickness 60 μm, wet) onto a Corona-pretreated polypropylene (PP) foil (temporary carrier), dried, and heat-conditioned at 70° C. for one hour. The film with the foil was then applied by lamination to an elastomeric, black-colored substrate at room temperature, using a rubber roll.

Substrate production: Acronal® S360 D, a polyacrylate dispersion from BASF, was diluted to 45% by weight solids content and colored with 2.5 parts by weight of Basacid Black per 100 parts by weight of polymer, and a film (layer thickness 450 μm wet) was produced from this material on a PP substrate.

The resultant laminate was heat-conditioned at 140° C. for 30 seconds in a drying cabinet, and the PP foil was peeled after cooling. The color properties of the resultant coating of the inventive film on the black polyacrylate substrate were assessed visually.

Visual Assessment:

Comparison: homogeneous film, color red, extensible by way of intense green to blue, reversible
Inventive example: as comparison, but markedly more intense and more brilliant colors; at 20% extension: intense green; at 40% extension: greenish blue; at 60% extension: blue

1. A process for improvement of the elasticity of a colored polymer system, which comprises a matrix and discrete polymer particles distributed in accordance with a defined spatial lattice structure in the matrix, and which is obtained by filming of an emulsion polymer with core/shell structure, where the emulsion polymer is obtainable obtained via polymerization of monomers in at least one first stage (monomers of the core) and subsequent polymerization of monomers in at least one further, second stage (monomers of the shell), which comprises using monomers whose glass transition temperature is below 0° C. as at least 5% by weight of the monomers of the core.

2. The process according to claim 1, wherein from 0.01 to 10% by weight of the monomers of the shell are composed of crosslinking monomers.

3. The process according to claim 1, wherein the polymerization of the monomers of the core takes place in the presence of an absorber for electromagnetic radiation.

4. The process according to claim 1, wherein ionic emulsifiers are used during the polymerization of the monomers of the core, and nonionic emulsifiers are used during the polymerization of the monomers of the shell, or vice versa.

5. The process according to claim 1, wherein the monomers of the shell are metered in during the polymerization reaction in less than 90 minutes.

6. The process according to claim 1, wherein the polymer particles of the colored polymer system comprise one or more types of particle whose average particle diameter is in the range from 0.05 to 5 μm, but where the polydispersity index (PI) of each type of particle is smaller than 0.6, calculated by the formula
P.I.=(D₉₀−D₁₀)/D₅₀
where D₉₀, D₁₀, and D₅₀ indicate particle diameters, for which the following applies:
D₉₀: the particle diameter of 90% by weight of the total weight of all of the particles is smaller than or equal to D₉₀
D₅₀: the particle diameter of 50% by weight of the total weight of all of the particles is smaller than or equal to D₅₀
D₁₀: the particle diameter of 10% by weight of the total weight of all of the particles is smaller than or equal to D₁₀.

7. The process according to claim 1, wherein the polymer particles of the colored polymer system comprise one type of particle.

8. The process according to claim 1, wherein the entire emulsion polymer comprises at least 40% by weight of what are known as main monomers, selected from C₁-C₂₀-alkyl(meth)acrylates, vinyl esters of carboxylic acids comprising up to 20 carbon atoms, vinylaromatics having up to 20 carbon atoms, ethylenically unsaturated nitrites, vinyl halides, vinyl ethers of alcohols comprising from 1 to 10 carbon atoms, aliphatic hydrocarbons having from 2 to 8 carbon atoms and one or two double bonds, or mixtures of these monomers.

9. The process according to claim 1, wherein the polymer particles of the colored polymer system and the matrix differ in refractive index.

10. The process according to claim 1, wherein the difference in refractive index is at least 0.01.

11. The process according to claim 1, wherein the polydispersity index, as defined in claim 6, of the discrete polymer particles is smaller than 0.45.

12. The process according to claim 1, wherein the core of the emulsion polymer has been crosslinked.

13. The process according to claim 1, wherein the ratio by weight of the core to the shell in the emulsion polymer is from 1:0.05 to 1:20.

14. The process according to claim 1, wherein the distance between the discrete polymer particles of the colored polymer layer is from 20 to 50 000 nanometers.

15. The process according to claim 1, wherein the entire polymer of the transparent layer comprises at least 40% by weight of what are known as main monomers, selected from C₁-C₂₀-alkyl(meth)acrylates, vinyl esters of carboxylic acids comprising up to 20 carbon atoms, vinylaromatics having up to 20 carbon atoms, ethylenically unsaturated nitrites, vinyl halides, vinyl ethers of alcohols comprising from 1 to 10 carbon atoms, aliphatic hydrocarbons having from 2 to 8 carbon atoms and one or two double bonds, or mixtures of these monomers.

16. A colored polymer system, obtained by the process according to claim 1.

17. (canceled)

18. A process for producing substrates coated with the colored polymer system according to claim 16, which comprises applying the polymer system to a temporary carrier, then transferring the coated side of the resultant coated carrier onto the substrate and, if appropriate, then peeling the temporary carrier.

19. The process according to claim 1, wherein the difference in refractive index is at least 0.1.

20. The process according to claim 18, wherein the application of the polymer system to a temporary carrier is carried out via filming of an aqueous polymer system or via extrusion.

21. The process according to claim 18, wherein the transfer of the coated side of the resultant coated carrier onto the substrate is carried out via lamination or pressing.
